(19) United States
(12) Patent Application Publication
(10) Pub. No.: US 2010/0293580 A1
(43) Pub. Date: Nov. 18, 2010

(54) REALTIME VIDEO NETWORK

(76) Inventor: David P. Latchman, Toronto (CA)

Correspondence Address: COATS & BENNETT, PLLC, 1400 Crescent Green, Suite 300, Cary, NC, 27518, US

(21) Appl. No.: 12/464,510

(22) Filed: May 12, 2009

(51) Int. Cl. H04N 7/20

(52) U.S. Cl. 725/71; 348/148; 348/E07.085

(57) ABSTRACT

A real-time video network has remote mobile vehicles operating on land, sea and air, each mounted with one or more video cameras. The video feeds from these video cameras is transmitted real-time via satellite to one or more earth stations and to one or more network operation centers. The network operation center previews, selects, consolidates and aggregates the video feeds from the mobile vehicles. Distribution networks are used to communicate one or more video streams, feeds or channels to display devices for viewing. Operators at the network operation center or the end user can select which video feed to view.

### FIELD OF THE INVENTION

This invention relates to the generation and distribution of video. In particular, the invention relates to real-time video content over a network.

### BACKGROUND OF THE INVENTION

Media companies generally create content that is packaged and delivered to consumers of media. Television, for example, involves television cameras recording a scene. A representation of the recording is generally either recorded to video tape or an electronic media or sent to a production centre for distribution.

Most television stations display pre-recorded video content that may have been recorded days, months or even years earlier. The content may be edited or re-arranged from the original recording, usually in to shorter segments that are not continuous reproductions of the original recording. There is generally no association between when the content was recorded and when it is being watched. A television company, such as a broadcaster or producer, packages the content and delivers them at a time of its choosing. Video recordings may be stored or archived for future use.

Some events are broadcast ‘live’ to the viewers. A live broadcast means that a viewer sees the video broadcast in near real-time to the actual event. There are often communication and network delays which may cause the displayed video to delay the actual event by several seconds or as long as a minute. In addition, intentional delays may be introduced to allow blocking of inappropriate content. A live broadcast is not stored or edited before being distributed. A video camera's captured image data is transmitted from the location of the event over cables or wireless transmission, such as satellite to the production centre and from there, distributed to viewers. Re-plays and pre-recorded components may be inserted in to the ‘live’ broadcast. Even with live broadcasts, the video is often interrupted with re-plays and pre-recorded video. In addition, the live broadcast usually ends at the end of the event being broadcast and the broadcast continues with pre-recorded content.

In order to broadcast ‘live’ events, equipment has to be installed or transported to the event. For example, broadcast production vehicles may have to be positioned near the event with communication systems back to the production centre. Many companies use terrestrial line-of-sight radio communications vehicles with transmitters that usually extend above the height of the vehicle to be less obstructed by other vehicles, trees and buildings and improve communications. The communication range of these vehicles is usually limited to urban areas where the necessary terrestrial receiver equipment is installed.

Other systems may use satellite communications to transmit video captures from a vehicle to an orbiting satellite and back to a receiver ground station. Setting up equipment, such as a satellite truck or van to transmit to satellite generally takes time and is generally done from stationary fixed positions.

Since satellites are generally visible to transmitters and receivers from most areas, ‘live’ events can be captured and distributed from more locations via satellite than using terrestrial line-of-sight equipment.

It is therefore desirable to have mobile vehicles continually generating and transmitting live video from multiple video cameras located in remote locations.

### BRIEF DESCRIPTION OF THE DRAWINGS

In drawings which illustrate by way of example only a preferred embodiment of the invention,

FIG. 1 is a schematic overview of an embodiment of the invention.

FIG. 2 is a more detailed overview of an embodiment of the invention.

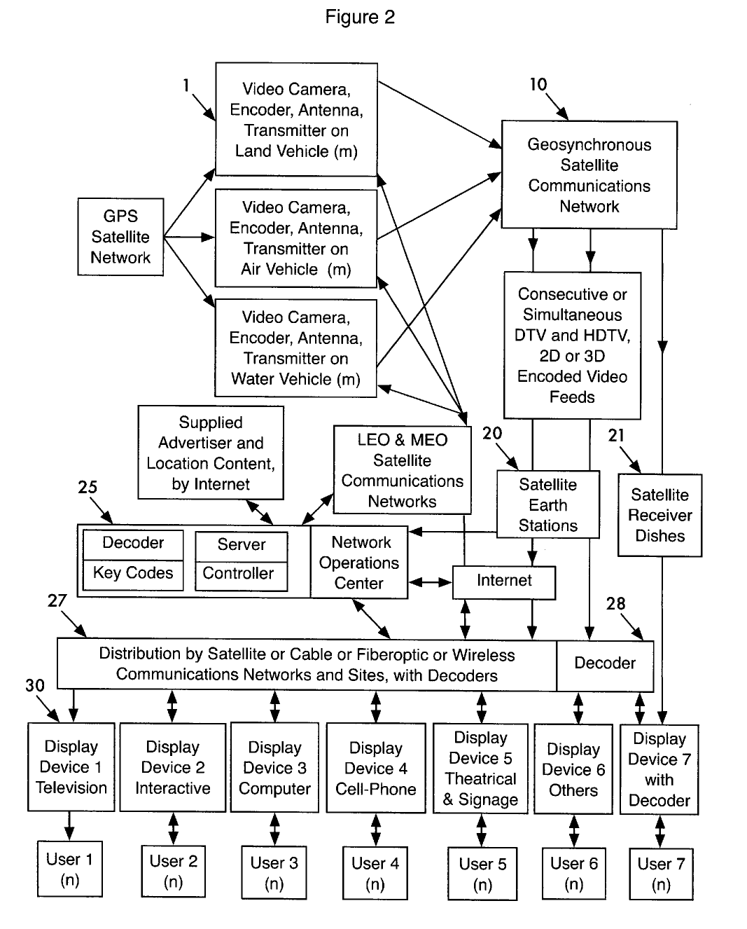

FIG. 3 is a logical representation of a mobile vehicle of an embodiment of the invention.

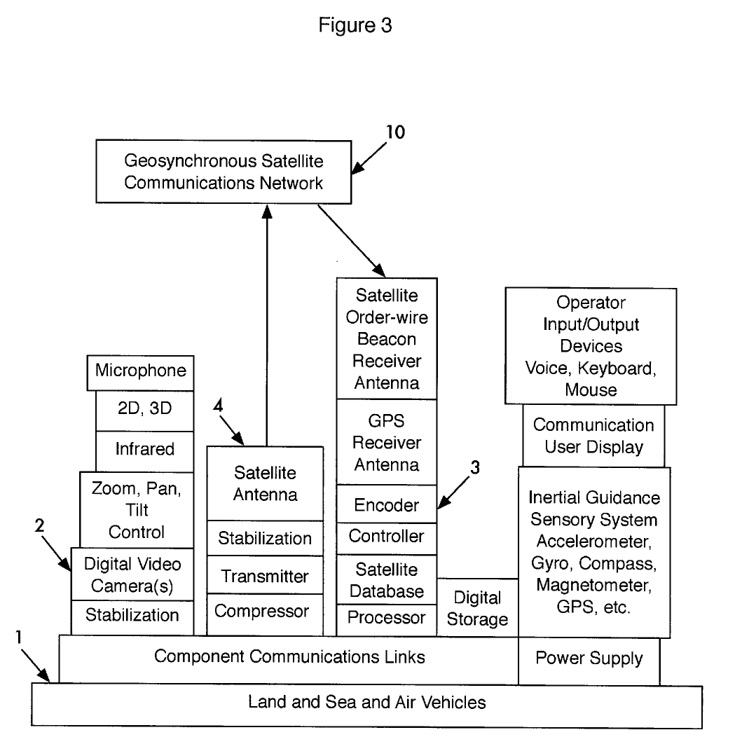

FIG. 4 is a representation of a network of mobile vehicles of an embodiment of the invention.

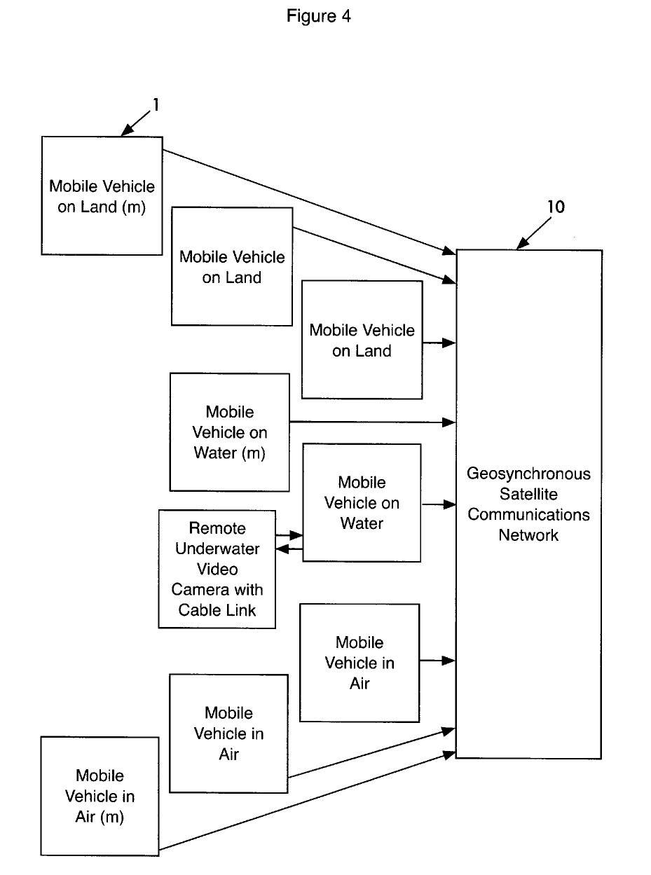

### DETAILED DESCRIPTION OF THE INVENTION

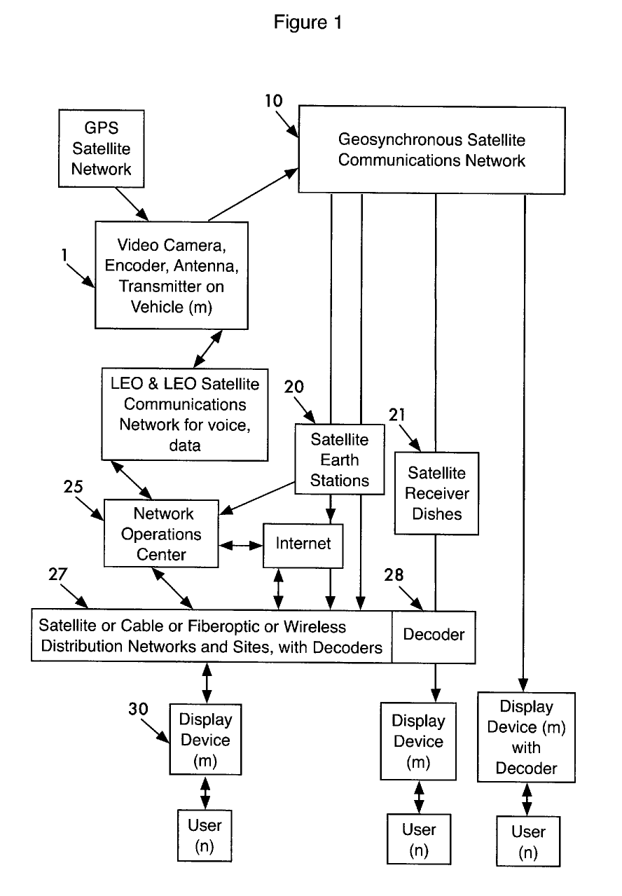

A preferred embodiment of the invention is generally shown in FIG. 1. A mobile vehicle 1 transmits video feeds from an imaging device such as a digital video camera 2 to a satellite 10. The satellite receives the video feeds and transmits the video feeds to an earth station 20 and network operations centre 25. The network operations centre previews the video feeds and manages the transmission of the feeds for distribution. The video feeds are transmitted to at least one distribution network 27 for distributing the video feeds to a display device 30 for viewing by a user. The transmission of the signal from the mobile vehicle 1 to the display device 30 is generally ‘live’ (not substantially delayed).

The mobile vehicle 1, may be a vehicle for operation on land, such as a car, truck or train, in the water such as boat, submersible or submarine, or in the air such as helicopter, plane, or airship. The vehicle may be operated by a person in the vehicle, such as a car, or remotely such as an aerial drone. The vehicle may also be autonomous and operated by a computer system either on the vehicle or remotely.

The mobile vehicle 1, contains at least one imaging device such as a camera 2 for capturing the scene in video in the vicinity of the vehicle. The camera 2 captures video, either in standard formats or high definition, and preferably includes or is used in conjunction with a microphone to capture sounds. The camera 2 may have telephoto or wide angle capturing capabilities, or both. The camera 2 may have tilt and pan capabilities controllable by computer, an operator on the vehicle 1 or by a remote operator. The controller, either the computer, operator on the vehicle 1 or the remote operator may also control telephoto and wide angle capabilities and the microphone. The camera 2 may be specialized to operate in different environments, such as in the dark or underwater. The camera 2 may use non-visual light such as infrared light. The camera 2 may capture a representation of its surroundings in three dimensions. The camera 2 may be mounted on the vehicle 1 in a manner that minimizes vibrations and shaking using, mechanical, electrical or electro-mechanical video stabilization, such as gyroscopes with dampening. In addition, the camera 2 may be mounted on the vehicle 1 in such a way they are not obstructed by the vehicle 1 such as on a boom or robotic arm attached to the vehicle 1. A single vehicle 1 may contain more than one camera 2. If there is more than one camera 2, they may operate together, for example a telephoto view and a wide angle view of the same scene or separately, for example a view forward from the vehicle 1 and a view out the back of the vehicle 1.

A mobile vehicle 1, which may be a car, thus contains at least one imaging device such as a camera 2, for recording the scene around the vehicle 1. The mobile vehicle 1 also contains a satellite transmission system 4, suitable for transmitting video signals (and any accompanying audio and other ancillary signals) to a satellite 10. The mobile vehicle 1 may also transmit other information such as the vehicle's location, and speed, orientation of the camera 2 and the date and time of the capture. This information is referred to as metadata. The location of the vehicle may be determined using the satellite based GPS system but the mobile vehicle 1 may use other means, such as inertial guidance or sensory systems to determine its location.

The camera 2 may use a through-the-lens system to identify where the video camera is pointing based on its orientation and zoom level. Video signals and metadata from one or more of the video cameras 2 is transmitted to the satellite 10. Identifiers for the vehicle 1 and camera 2 may also be transmitted.

The satellite transmission system 4 on the mobile vehicle 1, such as an electronic array and beam-forming antenna, may be steerable, stabilized and automatically controlled, such as by a computer, to point the transmitted signal at the satellite 10. The satellite transmission system 4 may need to adjust the system as the mobile vehicle 1 or transmission system 4 moves or changes orientation, changes detected using sensors on the vehicle 1 such as one or more of accelerometers, magnetometers, inertial guidance systems, a satellite beacon receiver and GPS. It may also need to adjust as the satellite orbits the earth preferably using order-wire beacon information transmitted by the satellite or satellite provider. Since the video feeds are transmitted via satellite, the mobile vehicle 1 has the ability to move to most locations on earth and still transmit video signals both at the new location and while in transit. The mobile vehicle 1 is not limited by cables or direct terrestrial line-of-sight transmission from the vehicle 1 to a earth station.

The mobile vehicle 1, may alternatively use other means of communication, including terrestrial transmissions such as 3G or WiMax when available or when satellite communication is unavailable.

The vehicle 1 may also store the video stream on the vehicle 1, such as in short term or long term storage. This stored video may be transmitted at any later time. Short term storage may be in electronic memory such as RAM and longer term storage may be via magnetic disk, a hard drive or tape.

A satellite 10, receives video signals from the mobile vehicle 1 along with the metadata and any identifier information. The satellite 10 is preferably a geosynchronous satellite, part of a network of geosynchronous satellites or one of a network of low earth orbit or medium earth orbit satellites that are passing over the mobile vehicle. The satellite 10 may be a commercial satellite used for a variety of purposes and bandwidth leased for use with this system.

The satellite 10 receives the signals from the mobile vehicle 1 and transmits the video signals back to the ground to one or more earth stations 20. An earth station generally contains means for receiving the video (and ancillary data) transmissions from the satellite 10. The video signals may be split between the one or more earth stations 20 based on the geographic location of the vehicles 1, the type of event being captured or some other criteria.

The earth station 20 is connected to a network operation center (NOC) 25, contains a video managing device for switching, monitoring, previewing, mixing, managing and controlling the video feeds received from the cameras on the mobile vehicles. The NOC 25 may be in the same facility as the earth station 20 or in a separate facility. Depending on the proximity of the network operation center 25, a communication link, such as cable, fibre optic or other preferably high bandwidth link may be used between the network operation center 25 and earth station 20. The mixing equipment may allow video feeds from multiple cameras 2 to be combined in a single video feed such as using split screen or picture-in-picture arrangements. The video feeds from the cameras 2 may be selected in any combination or permutation, providing multiple content feeds. The video feeds may be arranged in bundles, or channels based on the thematic content of the feeds, geographic location they originate or likely interest of viewers. An operator at the NOC may select which video feeds received from the cameras are distributed to the display devices 30. In an alternative embodiment, a user at the display device 30 may select a particular video feed to be displayed on the display device 30 from those available. Other data may be added to the video feed, such as metadata, advertising, maps, pre-recorded material or background information relating to the subject matter of the video feed.

Additionally, the NOC 25 may communicate with the mobile vehicle 1 to control and manage the location, coverage and movement of the vehicle 1 or the direction and orientation of the cameras 2 mounted on the vehicle 1. As would be within the knowledge of a person skilled in the art, NOC 25 communication with the mobile vehicle 1, may be done using any suitable communications means, including satellite and cellphone.

The display device 30 is a device able to display video signals, such as a television, computer monitor, cell phone, handheld device, or theatrical large screen display device. The display device may also be specialized display equipment such as a projection system or immersion screen capable of displaying video around a human viewer. The video feeds from the satellite, NOC or other distribution sites may be transmitted through known television broadcast technology or other electronic distribution such as satellite, wireless, or over a network such as the Internet. The display device 30 may be stationary and located in a user's home or office or mobile, such in a vehicle or mobile phone or in a public venue such as a bar or theatre. The user of the display device 30 may interact with the video feed by, for example, using the Internet or websites, selecting background material, purchasing goods or services or selecting alternative video feeds or channels.

The NOC 25, or earth stations 20 may receive the video signals or feeds from the satellite 10 via an intermediary such as a satellite receiving company or the company from which the satellite services are leased.

In one embodiment, the video feeds transmitted from the mobile vehicle 1 are encoded with an identifier for the camera 2 and vehicle 1 using an encoder 3 on the vehicle. The video feed is decoded at the NOC 25. Alternate distribution sites, including alternative earth stations 20 or satellite dishes 21 may be used to distribute video feeds to display devices 30. A decoder key may be transmitted from the NOC to the alternative distribution sites, so that video feeds received at alternative earth stations from the satellite network 10 can be decoded. Alternatively, the decoder keys may be transmitted from the NOC to the display devices 30 or to intermediate controllers in the distribution network 27 between the earth stations and display devices 30 to decode the signals using a decoder 28. The encoding and decoding provide security and distribution rights control and management to limit theft and misuse of the signals.

In operation, one or more mobile vehicles 1 transmit video feeds from one or more of their video cameras 2. The video feeds are transmitted via one or more satellites 10 to one or more earth stations 20. These feeds are managed at one or more network operation centers 25. In the preferred embodiment, the video feeds are continuously captured and transmitted to a network operation center 25 and on to display devices 30 without interruption for minutes, hours or days at a time as the mobile vehicle moves and changes location and orientation. For example, an airplane may be a mobile vehicle and distribute video of a flight across the continent.

At the display device 30, the substantially continuous video feeds are displayed to a user. Preferably the user can select from one or more channels of video content, such as channels relating to weather, atmospheric conditions, animals, nature, human habitat, activities, construction, architecture, processes, etc. As an example, the user may select to view the video captured by the airplane and view the video for the duration of the plane's flight across the continent.

Using the metadata transmitted from the mobile vehicle 1, the display device 30 may display the location of the vehicle or details on what is being seen on the video. The operators or equipment at the network operation centre 25 will preferably analyze and manage the metadata from the mobile vehicle 1 and select information to be incorporated in to the video signals transmitted to the display devices 30.

Using this system, a user viewing a display device 30 receives a selection of real-time video feeds from one or more mobile vehicles 1 that can be located almost anywhere on earth. The video feeds may contain video relating to natural events in nature, weather, animal and human habitat, man-made objects and events or other events from the planet—anything viewable from a mobile vehicle 1.

In an alternate embodiment, the video feeds received from the mobile vehicles 1 are archived or stored at the vehicle 1 or network operation center 25 or in a facility in communication with the network operation center 25. The archived material may be made available for distribution at display devices at a later time, on television or streamed or downloaded over a network, such as the Internet, on demand by viewers.

Various embodiments of the present invention having been thus described in detail by way of example, it will be apparent to those skilled in the art that variations and modifications may be made without departing from the invention.

I claim:

1. A real-time video capture and distribution system for communicating video channels to users comprising:
a) at least one mobile vehicle, the at least one mobile vehicle having at least one digital video camera producing at least one video feed;
b) a satellite communication network for communicating the video feed produced from each of the at least one digital video cameras;
c) an earth station for receiving the at least one video feed from the satellite communication network;
d) a network operation centre for receiving from the earth station previews of the video feeds and managing the video feeds into channels;
e) a network for distributing the channels to a plurality of viewing devices.

2. The system of claim 1 further comprises a controller for controlling the location, movement and direction of the at least one mobile vehicle and the at least one cameras.

3. The system of claim 1 wherein the at least one video camera comprises a high definition video camera.

4. The system of claim 1 wherein the at least one video camera is mounted to the at least one vehicle using mechanical, electrical or electro-mechanical video image stabilization.

5. A method of creating and distributing real-time video to viewers comprising the steps of:
a) creating at least one video feed from at least one mobile vehicle using at least one video camera;
b) communicating the at least one video feed from the mobile vehicle to an earth station using at least one satellite;
c) communicating the at least one video feed from the earth station to a network operation center;
d) previewing and managing the at least one video feed at a network operations center to create at least one video channel;
e) communicating the at least one video channel to a plurality of viewing devices.

6. A network operation center for a distribution system for communicating video feeds to a plurality of viewing devices from at least one mobile vehicle comprising:
a) means for receiving the video feeds from at least one camera mounted on the at least one mobile vehicle transmitted via at least one satellite;
b) a previewer for previewing the video feeds;
c) at least one managing device for organizing and managing the video feeds;
d) a means for transmitting at least one video feed or combined video feed to a plurality of viewing devices.

7. The network operation center of claim 6 wherein the means for receiving video feeds comprises a satellite receiver for receiving video feeds from a geostationary satellite.

8. The network operation center of claim 6 wherein the means for transmitting the at least one video feed or combined video feed comprises the at least one satellite.

9. The network operation centre of claim 6 wherein the means for transmitting the at least one video feed or combined video feed comprises a network.

10. The network operation centre of claim 6 wherein the at least one managing device comprises a mixer or a switcher or both.
